(19) United States
(12) Patent Application Publication
(10) Pub. No.: US 2018/0005428 A1
(43) Pub. Date: Jan. 4, 2018

(54) METHOD AND APPARATUS FOR GENERATING GRAPHIC IMAGES

(71) Applicants: Carlos Montero, Los Gatos, CA (US); Dane Glasgow, Los Gatos, CA (US)

(72) Inventors: Carlos Montero, Los Gatos, CA (US); Dane Glasgow, Los Gatos, CA (US)

(21) Appl. No.: 15/196,058

(22) Filed: Jun. 29, 2016

(51) Int. Cl. G06T 15/04; G06T 13/20

(52) U.S. Cl. CPC G06T 15/04; G06T 13/20

(57) ABSTRACT

Methods and apparatuses to generate various graphic features, such as fur and hair by modeling features using non-linear contours and positioning a number of intermediate shells to achieve a realistic appearance. These enhancements result in reduced processing time. The intermediate shells may be generated by interpolation of the base and final shells. These processes may be used to build a variety of features, and are particularly suited for grass, hair, fur and so forth.

### FIELD OF THE INVENTION

The present invention relates to graphic images and animation, and specifically to generation of features to be displayed in a graphics engine.

### BACKGROUND

When creating an animated environment, such as in a real-time graphics engine for a video game, the overall quality is related to the realistic visual quality of the characters and environments. When the visual quality tracks closely to reality, the experience is considered more believable and immersive. This reduces the experience for the user, and makes it difficult for the creator or author to express their ideas, stories, movies, games, and so forth. Similarly, when creating an animated video, it is desirable to have more flexibility and control over the behavior of images, such as to show a character's hair flowing in the wind, or the changes in the fur on an animal as the animal moves, increasing the viewing experience. The ability to create, design, and render life-like characters increases the level of realism to a variety of applications. These applications include gaming, modeling, multi-media, virtual reality, augmented reality, and others. This realism increases the required processing power and speed of the displaying computer.

### BRIEF DESCRIPTION OF THE FIGURES

FIG. 1A illustrates a grouping of polygons for modeling fur using a nodal architecture according to prior art techniques.

FIG. 1B illustrates a grouping of polygons for modeling hair, according to prior art techniques.

FIG. 2A illustrates a grouping of polygons for modeling fur using a nodal architecture, according to prior art techniques.

FIG. 2B illustrates a grouping of polygons for modeling hair, according to prior art techniques.

FIG. 3 illustrates a process for generating a graphic feature, such as fur, according to example embodiments of the present invention.

FIG. 4 illustrates a process for generating intermediate shells in the graphic feature, such as fur, as in FIG. 3, according to example embodiments of the present invention.

FIGS. 5-7 illustrate shells and their positioning to form a graphic feature, such as fur, according to some embodiments of the present invention.

FIGS. 8-11 illustrate textured shell layers patterning a graphic feature, such as fur, according to some embodiments of the present invention.

FIG. 12 illustrates a control mechanism for generating a graphic feature, such as fur, according to some embodiments of the present invention.

FIGS. 13-16 illustrate application of processes for generating graphic features, such as fur, to create an image, according to some embodiments of the present invention.

FIG. 17 illustrates expression of a graphic feature, such as fur, having a base, and textured shells, top and intermediate, according to some embodiments of the present invention.

FIGS. 18-29 illustrate texturing and patterning for generating a graphic feature, such as fur, according to some embodiments of the present invention.

FIGS. 30-31 illustrate textures modeled to generate a graphic feature, such as hair, according to some embodiments of the present invention.

FIGS. 32-33 illustrate hair structures built by generating graphic features, such as hair, according to some embodiments of the present invention.

FIGS. 34-36 illustrate a character having hair structures built by generating graphic features, such as hair, according to some embodiments of the present invention.

FIGS. 37-38 illustrate hair strands built by generating graphic features, such as hair, according to some embodiments of the present invention.

FIGS. 39-40 illustrate a method for generating and revising graphic features, such as hair, according to some embodiments of the present invention.

FIG. 41 illustrates a method for generating graphic feature, according to some embodiments of the present invention.

FIG. 42 illustrates near distance shell compression, according to some embodiments of the present invention.

FIG. 43 illustrates a method for adjusting a shell configuration to illustrate movement of an object, according to some embodiments of the present invention.

FIG. 44 illustrates movement of an object using the method of FIG. 43.

FIG. 45 illustrates processes for generating various textures and patterns, according to some embodiments of the present invention.

FIG. 46 illustrates processes for enhancement of features by applying a random pattern, according to some embodiments of the present invention.

FIGS. 47-48 illustrate processes for generating vertex normal through interpolation for application in a feature graphic, according to some embodiments of the present invention.

FIG. 49 illustrates a method for standard interpolation and interpolation bend exponents for generating hair and fur, according to example embodiments of the present invention.

### DETAILED DESCRIPTION

The present invention describes methods and apparatuses for generating graphic features and structures for animation and video presentation. These features may be part of a real time rendering program, such as part of characters or scenery in a video game, movie, or other video presentation. The present invention is described herein with respect to hair and fur, but is applicable to other graphic features.

Features that are particularly difficult to simulate realistically include hair and fur. As used herein realistic does not necessarily mean real life, but rather includes the concept of bringing animation to life. The goal is to create a pleasant, smooth viewing experience for viewers. This is due to the density and complexity of hair and fur. In animation, a character's hair is made up of a large number of individual strands. In many current applications, these individual strands are treated as a single image, and the movement is not modeled in a realistic manner. The more realistic the video, the more it exemplifies the actual behavior of the hair strands. When generating these types of features, graphics limitations impact a realistic effect. There are many different aspects to creating fur and hair that have the visual properties necessary to appear believable.

There are a variety of techniques that have developed with real-time graphics engine advances, each having its own advantages and deficiencies. The current disadvantages for creating fur include the computational power required to generate each image or images. An example, to build a graphic feature for an animation of a bear requires significant computing power. The bear's the fur (or hair) covers the surface of the bear figure. As the bear moves there is a corresponding movement of the fur with respect to the bear. These types of movement also require significant amounts of memory to provide an accurate visual effect. The graphics design may move all the hair together, similar to a hat.

Fur is commonly represented as a flat surface with no volume or transparency. If transparency is added, it is added still in a flat, 2-dimensional way that breaks down at certain view-angles. The present invention presents solutions which give fur the volume, depth and transparency to be believable and realistic. When fur is modeled, each layer is built out of shapes defined by vertices or polygons. Polygons are used in computer graphics to create images that appear as three dimensional, which makes the video more pleasant to view or more realistic. In some methods, an object's surface is modeled using triangular, polygons to model an object's surface, vertices of the polygons are identified, and these shapes are used to render the object. Once modeling is completed, a video content is provided to a user for viewing, and the polygons are rendered to create the desired video image. The number polygons rendered impacts the speed and complexity of rendering. Additionally, the more curves and changes in the behavior of an object, the more polygons are changes and modified. Therefore, the more polygons used in modeling, the more realistic the result. Once modeled, the image is viewed as a video image. Each of these polygons are rendered for each frame. The more shapes that are generated at run time, the more computational power is required. This technique for generating fur and hair in animation use a process is called “shell texturing.” This process can also be used for grass, fabrics, or other organic and fibrous structures. There are, however, limitations to recreating natural believable visuals of fur using the current shell texturing techniques.

Shell texturing involves creating an illusion of structures, such as a millions of hair strands, using stacked shapes and transparency. The stack may be considered as planar slices of the object, which build to render the object. These polygons are used to form the shape of a surface, such as a furry creature's body, or other surface on which the fibrous material is to be formed.

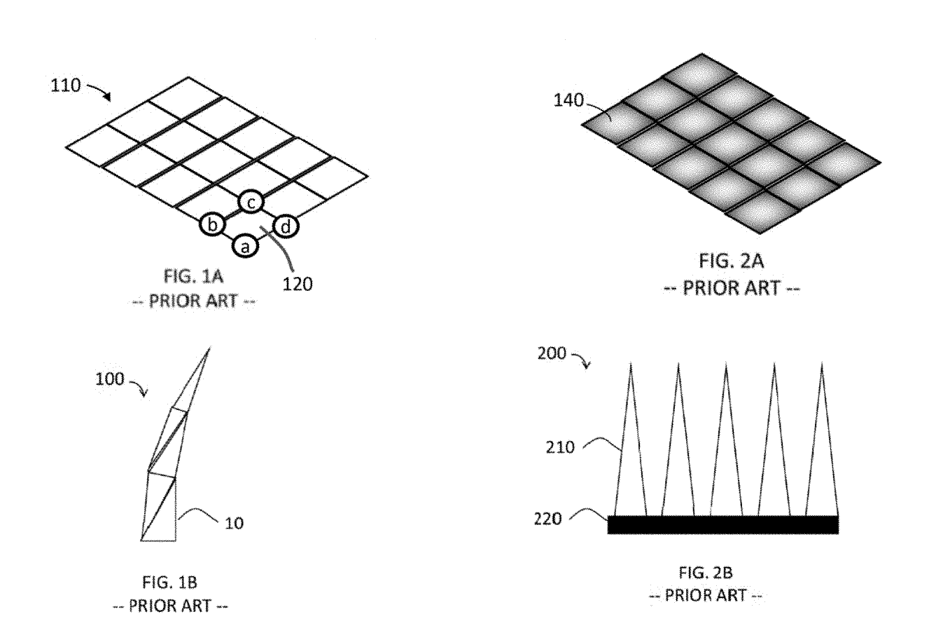

FIG. 1A illustrates a prior art shell as a layer in a three dimensional (3-D) model for a fibrous structure, such as fur on an animal for an animated video. The shell 110 is made up of a plurality of polygons, which in the illustrated example are rectangular, squares as shapes 120. The shell 110 includes many of these polygons. For clarity of understanding, the shell 110 is illustrated as a planar layer; however, many implementations will follow a contour or shape of the object, such as the body of an animal, the scalp, or other non-planar shape having a desired curvature. The polygons, such as squares 120, may be any of a variety of shapes, such as a triangular shape or other polygon shapes. The specific shape may be determined by the desired look of the animation, as well as other considerations for rendering and processing of the video content.

Each polygon, such as square 120, has a plurality of vertices, a, b, c, and d. A layer of fur is modeled using multiple shells, each having the same number of polygons, wherein vertices of a given polygon have coordinating vertices in each of the shells in the structure. Each polygon in a shell has similar polygons in other shells of the structure. Each polygon in a shell has transparent and/or colored portions to form a texture. This process is referred to as textured shells. As examples, FIG. 1A may illustrate fur on an animal, and FIG. 2A may illustrate hair on a character. FIG. 2A illustrates the shell 110 wherein a polygon 140 is textured. The texturing of shells in the structure is designed to create the individual strands of the fur. The texture is determined by the specific visual characteristics of the object.

Conventional textured shell structures use shell layers that are equidistant from each other over the entire shell. Shell layers may be considered as planar combinations of polygons. The layers are stacked to form a structure. Such structures create a uniform and simple visual appearance. The stack of shells creates a feature.

FIG. 1B illustrates a prior art feature made of polygons as configured in FIG. 1A. Each feature 100 is made up triangles, such as triangle 10, combined to simulate real fur or hair. Feature 100 is comprised of the various shell layers as in FIG. 1A. The polygons allow 3-D shapes to appear more natural or realistic. Alternate models may employ other polygon shapes, wherein the shapes are combined in any of a variety of ways. In FIG. 2B, these features 210, or strands, are grouped together on a surface, such as a plane 220. The grouping 200 of these polygon structures 210 creates the image of hair. As the number of polygons increases, the hair becomes more realistic looking when rendered. This rendering, however, requires increased computation time and resources as each polygon must be generated. It is desirable to have a method of creating realistic features efficiently.

The present invention is particularly applicable to fibrous elements, having multiple individual strands covering a surface having a non-planar contour. An example application is the graphic design of fur. Fur has many strands or elements making it computationally expensive to model each strand individually. In one embodiment a feature, fur is made of non-linear shells, wherein each shell is textured having colored portions and transparent portions, and wherein the shells are positioned with respect to each other in a non-uniform manner. The shells are not equidistant at all points of each shell.

The present invention defines a graphic feature as having a base shell, a base contour, a top shell and a top contour. Each shell is textured to create a feature. Textured shells have colored portions and transparent or semi-transparent portions. The colored portions in each shell take the form of the graphic features. Each graphic feature has a base shell with a first contour and a top shell having a final contour. For a strand of hair, the base shell and first contour correspond to an outer contour of the scalp of a character; the top shell and final contour corresponds to an end of the strand of hair. Intermediate shells are textured to achieve the image between the base and top shells.

The intermediate shells are designed to achieve a volume of the graphic feature. Unlike the prior art techniques, the intermediate shells are not uniformly equidistant from other shells across the entirety of the shell contour. In this way, each of the shells forming the graphic feature may have a different contour than other shells. The graphic feature may be further defined and adjusted by changing the texturing of polygons in each shell.

In some embodiments, the distance between shell vertices is used to define the shape of the feature. For example, the length of a strand of fur will be defined by the spacing of the shells. Building the shape of the strand of fur into the shell provides flexibility to the displayed image, such as to have the hair brushed back or to change the direction of the fur. This is not consistent with conventional techniques where the shells form linear structures. The use of the shell to build non-linear structures allows fast rendering with reduced computational effort. The base end points within the base shell for the strand of hair will be those points defining the shape of the hair. In this way, the shape is formed by defining a set of end points and the intermediate shape of hair. This is in contrast to conventional hair structures, where the shells are built around the geometric shape approximately perpendicular to the base shape, such as a scalp on a character. The present invention avoids the problems associated with the prior art techniques of FIGS. 1A, 1B, 2A and 2B.

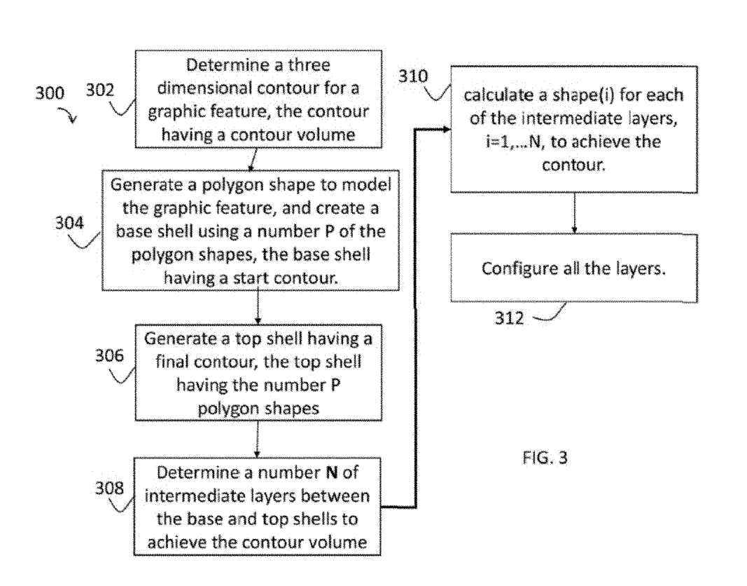

FIG. 3 illustrates a flow diagram of the process for building a graphic feature, such as fur, having a contour with volume. Here volume refers to the volume of the feature, such as a strand of hair which may have be thick at the base and grow thinner as it approaches its end. In such a case, the colored portion of the base shell will be larger than the color portion of the top shell. There are a variety of ways this may be implemented. A process 300 begins by determining a 3-D contour and volume for the graphic feature, 302. The volume of the graphic feature is used to create a variable density and appearance of the feature when rendered. From this information, the module generates polygon shape to model the graphic feature, 304. The polygon shape may be determined based on the desired granularity of the feature. Using the selected polygons, a base shell using a number of polygon shapes (P), a base shell is created using the polygon shape and configuration along a shape contour. The shape contour may be the shape of an animal. The shape contour follows the shape of the subject on which the graphic feature, such as fur, will be modeled. For example, where the subject is a cat, and the graphic feature is fur on the cat's face, then the contour shape would be the shape of the cat's face. As the contour shape is a 3-D shape, the base shell is defined by the contour of the subject's contour. A top shell is defined by a final contour having the P polygon shapes, the same number as in the base shell. The final contour is the desired outside final contour shape, 306. Continuing with the previous example of the cat, the final contour is the outer edge of the cat's facial fur. At this point, there is a base shell, having a base contour, and a top shell, having a final contour. The pair of the base and top shells are designed to achieve a desired volume.

Continuing with the process of FIG. 3, a number of intermediate layers, N, between the base and top shells to achieve the shape volume, 308, is determined. The intermediate shells each have the same number polygons, P, wherein the polygons are all the same shape. Each shape in a given shell has a corresponding similar shape in each of the other shells. From one shell to another, the polygon shapes are similar, meaning that they have corresponding vertices but may be scaled or proportional in size to each other. Further, as each shell may have a unique contour, the contour of individual polygons in different shells may be different. The contour volume of the graphic feature is achieved by the compilation of the shells, and provides a realistic appearance when viewed from different positions. In this way, when the modeled graphic feature is rendered in video form, it may be viewed from a variety of angles and perspectives, giving the viewer a rich experience. This is unlike conventional techniques which incorporate a flat structure, where shells are uniformly positioned to be equidistant from each other. The present invention builds a three dimensional shape with shape volume that presents the feature more realistically. Various embodiments of the present invention use non-linear configuration shells, so that the fur has volume. At this point, there is a base shell, having a base contour, a top shell, having a final contour, P polygons per shell, and N intermediate shells or layers. Using this information, the process continues to calculate a contour (or shape) for each of the N intermediate layers, and then stack all the layers. The use of non-linear shell structures allows for non-uniformity, creating variation in length and direction of the fur, which improves visual quality significantly.

According to various embodiments, the process 300 is used to generate a base shape of the contour in a base layer, such as to generate multiple single strands of fur. The base layer is along the outer contour of the object where the fur begins; therefore the base layer is designed to be darker and wider than layers built thereon. This models real life fur, where the fur gets finer and lighter in color farther from the base, or scalp. Similarly, the base layer may have less transparency and more color indicated in each polygon of the base shell.

Again, in a case of generating a strand of fur, the end of the fur strand farther from the scalp has more transparency and less color identified in the layer. As used herein, the terms layer and shell are effectively interchangeable. These steps have defined a start portion of the graphic feature and an end portion. The process 300 then determines a number, N, of intermediate layers between the base layer and the end layer, 308, wherein the N intermediate layers are stacked or configured to form the contour of the graphic feature. The selection of the number N is determined by the texture and appearance of the graphic feature, 310. The higher the value of N, the more fur-like the structure. In general, the higher the value of N, the more realistic the feature will appear.

Step 310 includes calculating a shape (i) for each intermediate shell (i), for i=1, 2, . . . , N. The shape or contour of each intermediate shell or layer is determined so as to achieve the contour volume. In one example, the strand of hair is curvaceous and requires a large number of intermediate shells to produce a realistic feature. In another example, the strand of hair is relatively consistent and therefore may incorporate a lower number of intermediate shells. The N intermediate shells may be determined by interpolation from the base shell contour to the top shell contour. In this way, given a start and end point, the shells are stacked to achieve the desired result.

The contour volume may be determined based on the desired movement of the graphic feature, such as fur that will blow in the wind, or grass that will be relatively static when rendered for display. The N shells build from the base shell to the top shell to form the contour of the graphic feature. The N layers have a variety of contours, wherein the contours taken together build the feature. The layers are stacked or configured together, step 312. In some embodiments, a library of contours for graphic features provides a selection to the designer. The specific base and top shell are specified and the intermediate shells are determined to achieve the contour desired.

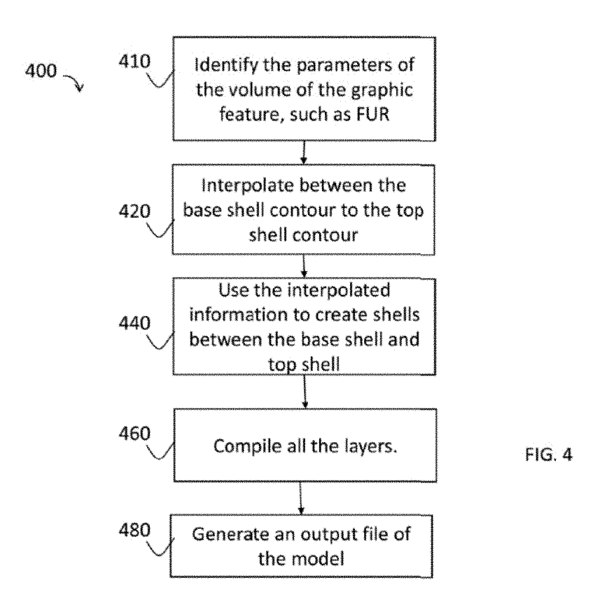

FIG. 4 illustrates a detailed embodiment of the steps 310, 312 of FIG. 3 to generate the intermediate shells of a graphic feature. First, identify the parameters of the volume of the graphic feature, 410. This may be determined by the relationship of the base shell and the top shell, or may have other features implemented. Determines the set of intermediate shells, 420. In some embodiments, the process uses interpolation to generate the contours of intermediate shells, 420, 440. Once the N intermediate shells are defined, the process stacks or configures the shells together to form the graphic structure, 460, and outputs a feature file, 480. The file or stored information to be used individually or part of a larger feature in a video work.

Consistent with FIGS. 3 and 4, FIG. 5 illustrates the generated base shell 504 and the top shell 502. In the illustrated example, the base shell is planar, however, any of the layers may have a curved or shaped surface or contour. The top shell 502 is illustrated, showing the varying or non-linear distance between the shells. This is due to the difference in curvature or definition of the shells. For clarity of understanding, the base shell 504 is illustrated as planar to clearly show the volume created between shell 504 and shell 502. The intermediate shells are built between these shells to form a feature.

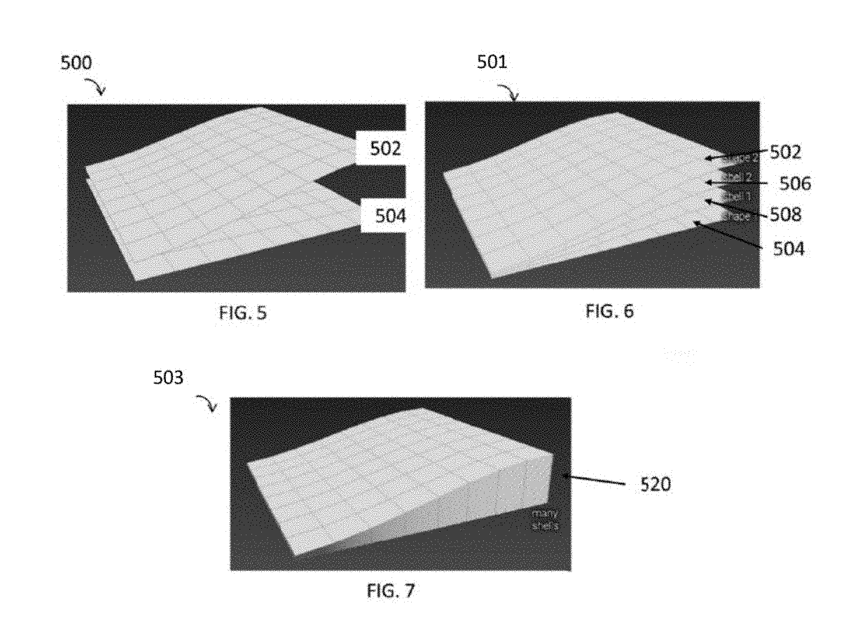

FIG. 6 illustrates the stack of shells, which is the configuration of the generated intermediate shells 506 and 508. There may be any number of intermediate shells, and two are illustrated for ease of description. The stack creates the volume from the base shell 504 to the top shell 502. In this way, the base shell 504 has a first area measure, the top shell 506 has a final area measure, and each intermediate shell has a specific area measure. When stacked together.

FIG. 7 illustrates the stack or compilation 520 of the N shells, which forms the contour having the contour volume. Note, FIGS. 5-7 are illustrations of the shells. Each of the shells 520 has a texture or pattern applied with colored portions and transparent portions (not shown); when compiled these patterns build to form the graphic feature. The stacked shells give an illusion of detailed geometric shapes without the use of such shapes, or the overhead associated with rendering these shapes.

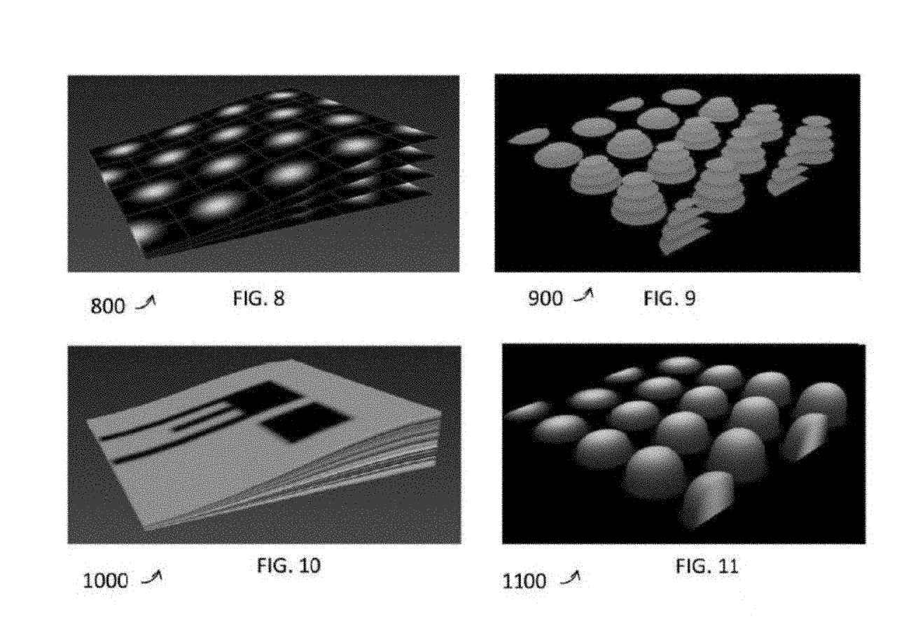

FIG. 8 illustrates the patterning of structure 800 having multiple shells. As illustrated, there are transparent portions, indicated in black, and opaque portions are illustrated in white. The opaque portions form the strands of the fur, having a first area or size in the base shell and corresponding shapes in the intermediate shell which terminate at the top shell. In this way the opaque portions of each polygon are matched with corresponding polygons in other shells to form the strands. In structure 800 the strands have a uniform structure from the base shell to the top shell, wherein the volume is determined to create a curvature of the strands.

FIG. 9 illustrates a structure 900 having multiple shells, wherein each shell has opaque and/or transparent portions. In structure 900, each strand of fur changes dimensions from one shell to another, such as where the strand is thick at the bottom and thins to a point at the end, top shell. The transparent portions are not visible and the colored portions form the graphic feature, such as the strands of fur. FIG. 9 illustrates the volume of a strand of hair from base shell to top shell, and also shows a contour of the surface of the features.

FIG. 10 illustrates a structure 1000 having various shapes implemented using a stacked textured shells. The top shell illustrates the graphic feature in black, and the other areas are transparent. The spacing between the shells is designed to achieve a desired result. As illustrated, the features have a curvature and defined volume. A variety of shapes and configurations are achievable with a variety of volumes.

FIG. 11 illustrates the shells 1100, where the number of layers N, the density of shells is sufficient to appear as a solid shape. In some embodiments, when the number of shells increases, the gaps between shells become imperceptible. This creates an illusion of a solid graphic feature. The individual shells include two dimensional shapes projected onto each shell; in combination, the shapes create a three dimensional structure with volume. The addition of volume creates a more realistic graphic feature that has a consistent appearance when viewed from a variety of angles.

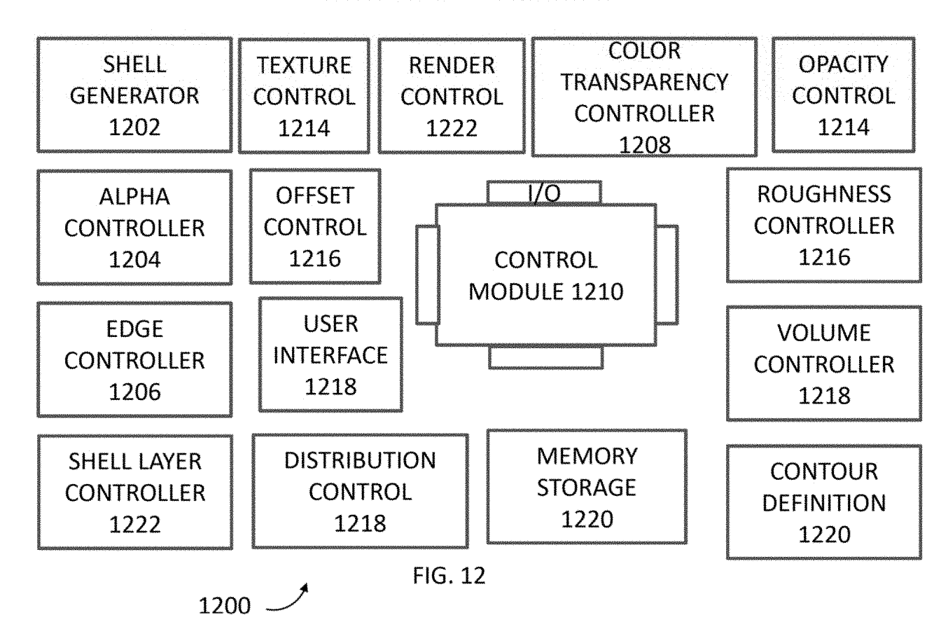

FIG. 12 illustrates a control apparatus 1200, implemented in computer-readable mediums and structures and that includes a plurality of software modules to control the contour shape and definition, layers, color, opacity, roughness, transparency, contour volume and edge properties. The control module 1210 controls the functionality of the apparatus. The apparatus 1200 may be a computer readable structure to receive information, calculate graphic feature parameters and generate an output file. The control apparatus 1200 includes a shell generator 1202 to generate each of the shells in the configuration of the graphic feature. Additionally, the control apparatus 1200 includes an alpha controller 1204, to control how a shape decreases in size from its base to its tip. Edge controller 1206 to detail the shape of the polygons used in a shell, wherein a shell may comprise various different polygons in various sizes. The color controller 1208 and transparency controller 1212 are used to generate the structures within the graphic feature. These determine the colored portions and transparent portions. The opacity controller 1214, roughness controller 1216, and contour definition controller 1220 enable further enhancement of the graphic feature. The volume controller 1218 defines the volume of the feature and the specific parameters of the feature in each shell. The contour shape and definition may be imported from a graphic design or may be built into the system. In some embodiments, a library of features in provided, such as grass, hair, fur and other fibrous features.

Shell layer control 1222 determines the number of shells to achieve a desired result. By adjusting this control, the designer is able to adjust the resultant look of the graphic feature. The opacity and transparency relate to portions of each shell as well as how the shells interact with each other when combined. The contour volume indicates the geometric volume of the graphic element. By controlling the volume, the size of the feature is adjusted. The combination of these controls may be provided in one or multiple modules, providing designers a variety of mechanisms to adjust features. Any of a variety of configurations are considered that may incorporate these and/or other modules to build features using multiple layers positioned non-equidistant from each other as a stack, as described hereinabove.

The system 1200 further includes a texture controller 1214 to develop and adjust the texture of shells. The offset controller 1216 and the distribution controller 1218 provide mechanisms for generating texture for a variety of processes and objects.

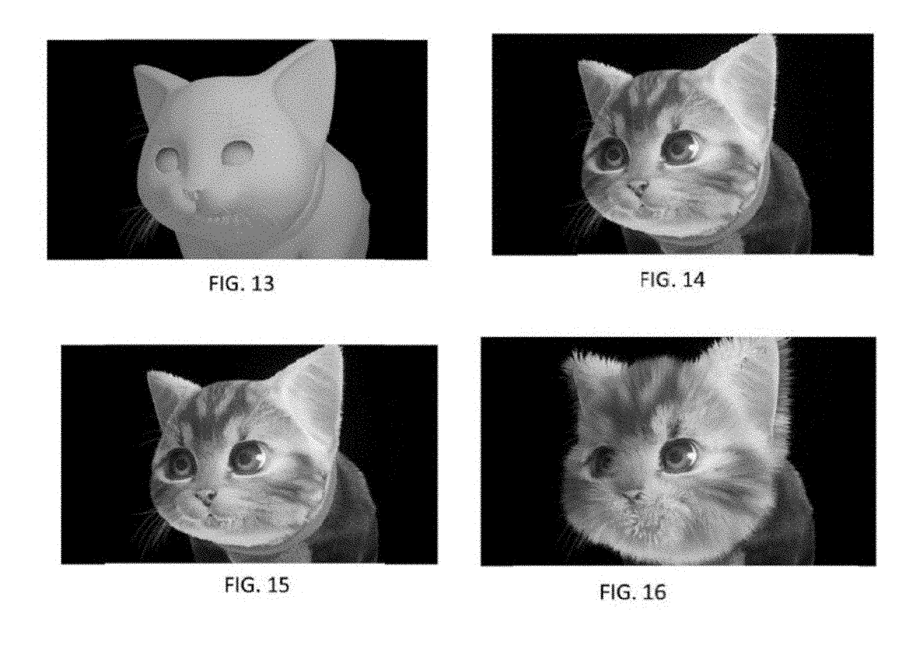

FIGS. 13-16 illustrate generation of graphic features for an animal, and control of some of the parameters of the feature. In this example, FIG. 13 is the drawing of a cat without any hair. This is the original or base contour of the cat. The shape provides the outline onto which the fur is to be placed. This is the contour of the base shell.

FIG. 14 illustrates a first application of the generated graphic feature, the fur. The color streaks are built into each shell, wherein the color and size taper off as they near the final shell by varying the colored and transparent portions of each shell. This is achieved as a polygon by arrangement of color and transparent portions to reflect the shading and intensity. Once configured, the configuration is modified and adjusted to achieve movement and flow to provide a realistic experience for the viewer.

Various controls are applied to change the look of the fur in FIGS. 15 and 16. Variables expose control of the relative spacing between shells, allowing the user to modulate spacing and achieve different visual effects. Closer spacing provides a denser look. Additional shells provide longer hair, which may scale as the number of shells increases as in FIG. 16.

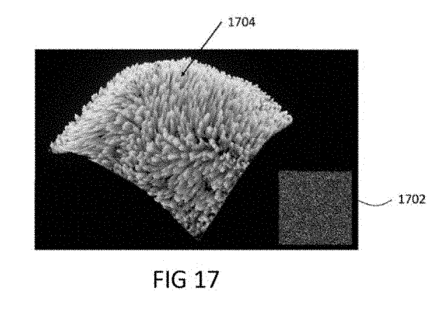

The pattern of color and transparency used in each shell determines the final look of the graphic feature. As illustrated in FIG. 17, varied patterns, such as pattern 1702, is applied to achieve a fur like appearance of the structure 1704. The volume of the fur and the curvature of the contour provide the look of fur. In the illustrated example, the strands are tapered toward the ends, achieved through different coloring and transparency in the shells. The pattern 1702 is a pattern of a single shell. The pattern may be repeated for the various shells or may be different for each shell. Each of the strands of fur in feature 1704 is generated as described hereinabove, by definition of a base shell and top shell of multiple polygons, and the calculation of intermediate shells according to the desired contour and attributes of the feature.

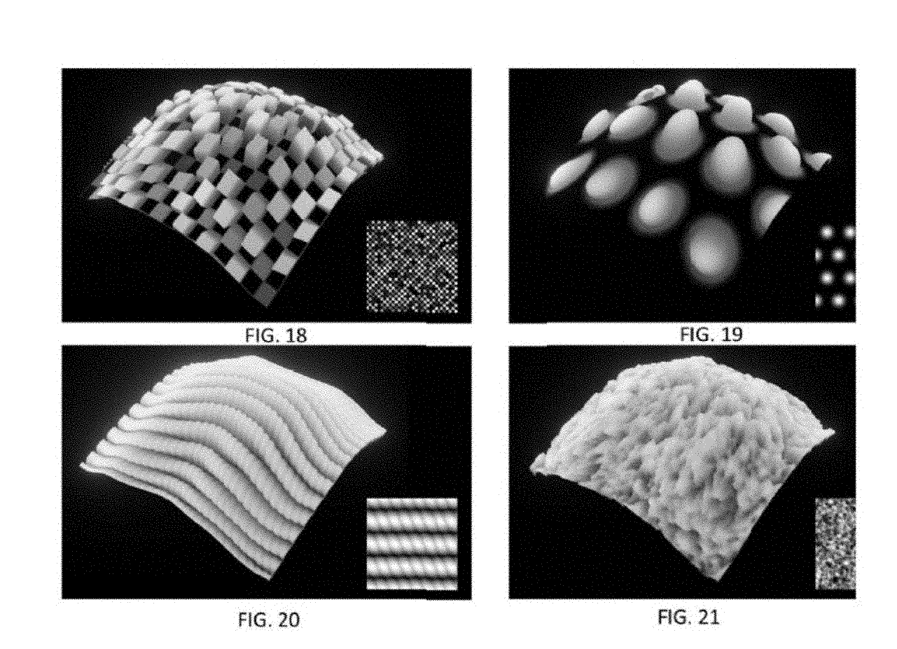

FIGS. 18-21 illustrate examples of results to create a given feature surface contour, color gradation, volume, polygon type and size, number of shells and configuration. Using similar polygon shapes, the desired effect may create the different images illustrated. The variety of patterns and features illustrates the flexibility of the present invention. By creating features using polygons and non-linear shells, the present invention provides flexibility and refinement and accuracy not available with conventional methods.

The patterns and features illustrated in FIGS. 18-21 are achieved by changing the coloring and transparency of each of the shells using a given contour and volume. In each of these structures, a base layer is generated, an end layer is generated and the intermediate layers are determined. In some embodiments, the intermediate layers are interpolated based on the base and end layer patterns. The patterns make dramatic differences to the resultant structures. The inset images are provided to illustrate a planar textured shell, while the main image has the contour of the feature, such as the cat body on which the fur is positioned.

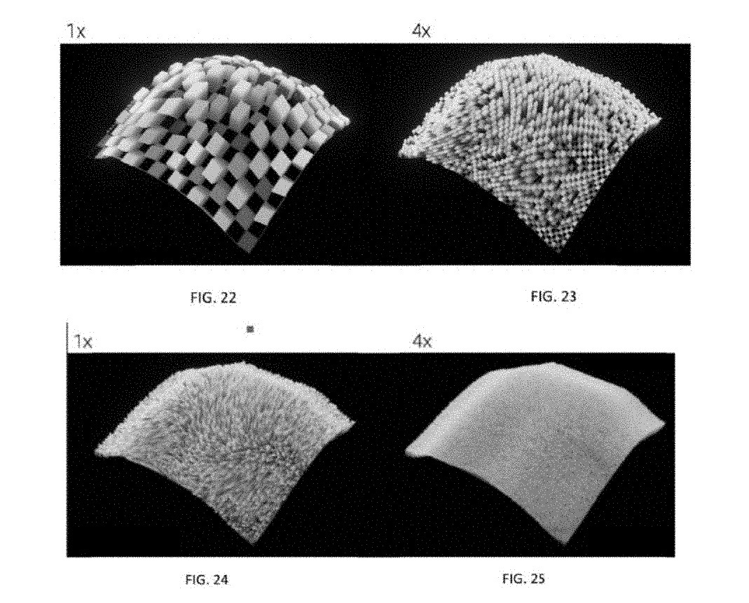

A noise controller may be adjusted to increase or decrease the density of pattern, which is an adjustment to the size of color portions of a layer or layers. FIG. 22 illustrates a noise pattern having a first density. The size and density of the noise pattern is changed, as illustrated in FIG. 23, to a second density, which is greater than the first density. The result is a more flowing appearance in FIG. 23. Similar changes are seen with the structures of FIGS. 24 and 25. In each of these successive illustrations, the density of the feature element is increased. This may be done reducing the size of the polygons used in the shells, or by changing the color/transparency portions. There is flexibility in the design, as the design parameters apply a third dimension to the shell, which applies a curvature to the shell. This creates a more realistic appearance and enhances the types of adjustments possible through selection of polygon shape and size, positioning of the shells with respect to each other, the start and end shells, and the calculations used to build the intermediate shells.

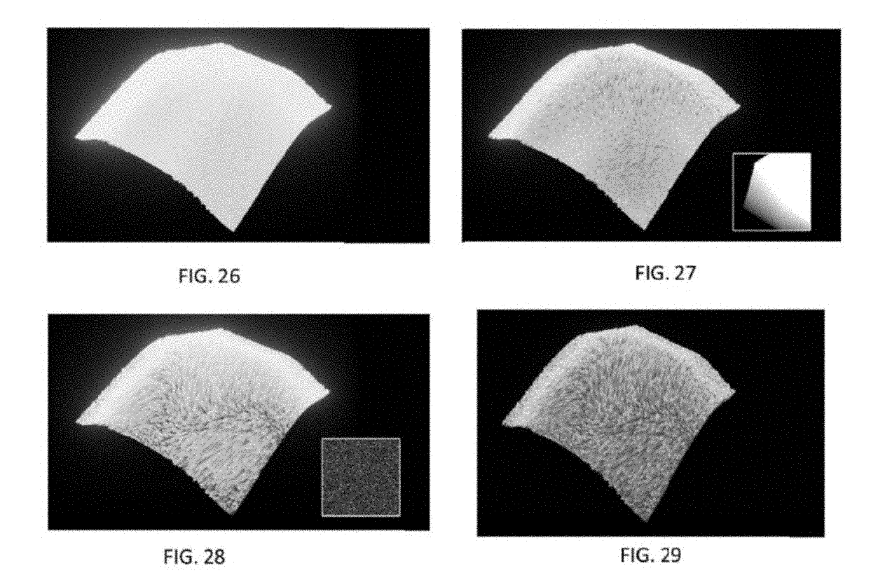

The features created using the present invention may exposed to a variety of environments, such as cat running through the woods, or when the lighting shades a portion of the animal or character. The fur or hair may reflect these changes by incorporating shadowing and lighting into the shells. In some embodiments lighting effects are incorporated into the layers, such as by providing darker patterns to some layers, such as the layers near the base layer. This achieves shadowing and lighting. Consider FIG. 26 which has no shadowing. By adding darker patterning to the lower layers, shadows appear in FIG. 27.

FIG. 28 illustrates a graphic feature incorporating patterns that change the direction of the hair. Here the procedural noise is multiplied into the texture of the graphic feature, filling the gaps between shapes to simulate a darker surface beneath them. In FIG. 29 both techniques are used to change the direction of the hair and to add the shadowing effects. This technique of darkening lower layers to give the illusion of contact shadows may be used in a variety of applications.

There are significant differences in fur and hair design, however, the present invention is applicable to both graphic features. By patterning the layers to achieve the desired volume of each graphic feature, there are a variety of designs that may be used.

As illustrated in the above examples, a process for generating a graphic feature uses a start and end model, wherein the base shell is formed according to the contour of the subject, and the top shell is formed to achieve the outer contour of the graphic feature, such as fur. Each shell is made up of multiple polygons having vertices. The vertices are indexed and have corresponding polygons in each consecutive shell. The resultant shape and volume of the structure is determined by the difference in the base shell and the top shell. The relationship between the contours of the base shell and top shell is non-linear, non-uniform.

In some embodiments the polygons in a shell are congruent. In some embodiments the polygons within a shell are not congruent and may include multiple different polygon shapes. The polygon shape defines the volume of the graphic feature, such as fur. The design is based on the graphic feature, the volume of the feature, the desired movement of the feature, the animation, the background, and other specifics as desired for the animation. A pattern, or texture, is applied to each shell to form the individual strands or portions of the graphic feature. Where the graphic feature is fur, the texture provides the form of the strands. The strands are then formed when the shells are compiled together.

The methods and apparatuses provided herein are applicable to generation of moss, grass, or other fibrous structures. A challenge in generating some types of graphic features, such as human hair, is the ability to change the direction of the individual hair and portions of hair, as well as to create realistic hair with volume. Conventional techniques design hair in a way similar to the way fur is modeled. See FIGS. 1A, 1B, 2A and 2B. Conventional techniques build strands of hair directed away from the scalp in an approximately perpendicular direction. These technique used to build the strands of hair incorporate polygons which must be rendered individually. This rendering increases the time required to present the video as well as the computational power required.

The present invention provides methods and apparatuses for easy rendering of hair, enabling more realistic images, by illustrating the shape of each strand within a shell, rather than building the strand shape by the compilation of shells.

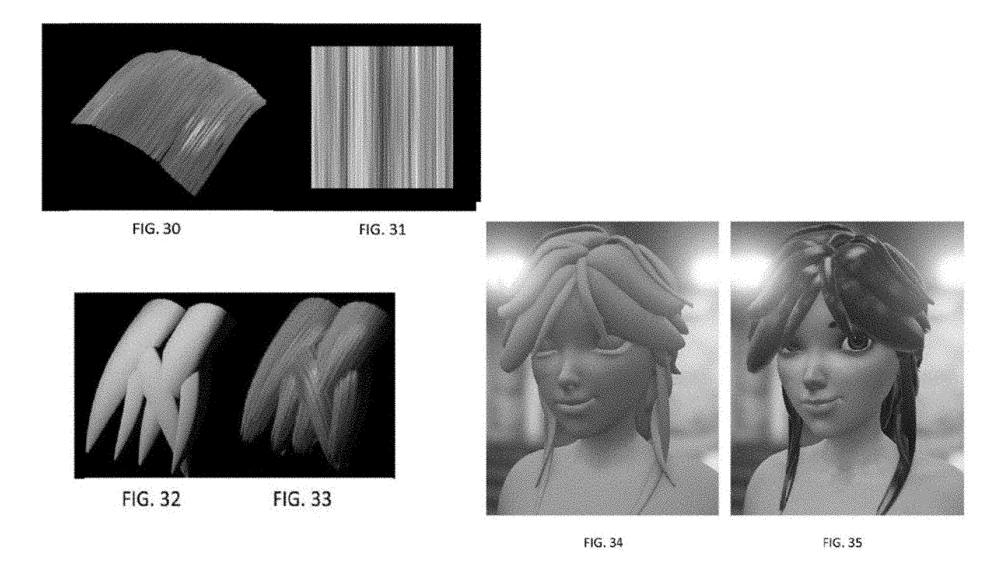

For hair structures, unlike the flat structures of conventional graphic features, the present invention allows the strands of hair to have patterning along the length of the layers or shells. This is illustrated in FIGS. 30 and 31. By positioning the patterning within the layer or shell, the direction of the hair may be configured and manipulated. In one example, a procedural strand texture controller is used to control the transparency of the shells. The texture controller may be included within the various controllers of FIG. 12, or may a separate module or modules. This is done to approximate the shape of the strands of hair along the surface of the stacked layers or shells. FIGS. 30 and 31, each illustrate a single shell of the hair structure. The patterning, or texturing, of a single shell is illustrated to draw the strand of hair along the shell. The texturing is distinctly different from that of the patterns used for fur, as in FIG. 17, pattern 1702. The patterns of FIGS. 30 and 31 clearly appear as hair strands, whereas the pattern 1702 appear as a random pattern of transparent and color portions. The shell of FIG. 30 has a contour shape that is not necessarily the shape of the subject, but rather the contour shape of the hair strands. This is in contrast to the methods and apparatus for generating fur. The present invention provides a method and apparatus for generating graphic images of hair and other fibrous materials, where the length of the hair is textured into each individual shell.

One embodiment of the present invention is applied to generate the tube like shapes of FIGS. 32 and 34 resulting in the look of FIGS. 33 and 35. The shape of the strand of hair is first built as in FIG. 32. The shapes of FIG. 32 are then configured as they are to appear on the subject, as in FIG. 34. The individual strands are built using the techniques described hereinabove. The resultant look approximates clumps of hair with high quality, complex intersections.

The hair strands of FIGS. 33 and 35 have a contour volume that is visible from different angles. The result is more realistic looking graphic features. The full graphic features are built using multiple shells, wherein the shells may be uniform distance from each other or otherwise. In each of the multiple shells, the hair strand is formed within the shell, and the compilation of layers helps the designer to achieve a desired volume, structure, density or other parameter that achieves a desired result. As animations are used in video games, movies, anime and other video works, the desired results may be determined by the desired end product. The present invention provides a method to create a 3-D realistic image of hair as desired for an animation.

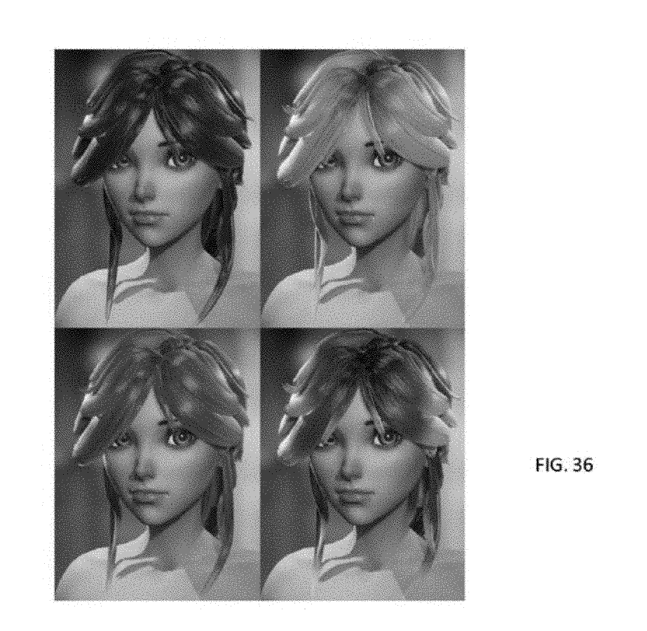

After generating the structures, the controls are used to modify and refine the look. For example, in FIG. 36, the controller may apply color changes to the contours created. Variables include hair color, which may be applied to any part of the graphic feature. This enables the designer to change the root color of the hair, or add color change to the tips of the hair. Similarly, the controller enables changes to the tip length of the hair or the ability to feather the hair. Other controls change hair density, hair reflections and so on. FIG. 36 illustrates some of the results of varying controls, such as color.

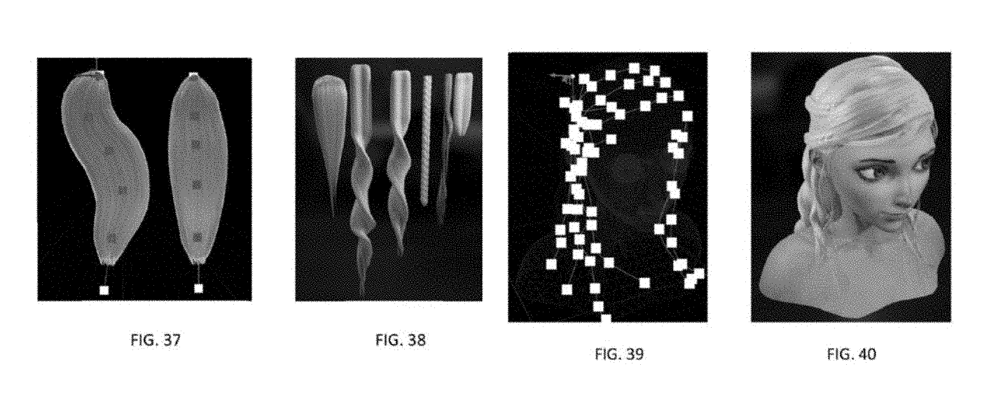

As the graphic features of the present invention have contour and volume, there are techniques that may be applied to enhance the appearance and add to the flexibility of the designer. FIG. 37 illustrates a strand of hair to which control points, or splines, have been added to enable modeling of the hair structure and movement in a real-time engine. This is a significant advancement over current techniques which require the artist to use a separate 3-D modeling program or tool to change the shape of the hair each time a change is desired. Real-time adjustments and positioning not only provides a more streamlined process but also enables the artist and designer to better understand how changes will impact the overall look and experience of the viewer.

A spine is used to assist in designing the curve of a strand of hair, or other feature. in computer graphics. A spline is a curve that connects two or more specific points, or that is defined by two or more points. The term can also refer to the calculation that defines a curve. According to some embodiments, the splines are placed in the hair pre-rendering, and are controllable in the real-time engine. The designer is able to view how the feature will be viewed in the game at run time. A hierarchy may be assigned to the splines from the beginning, avoiding the additional step(s) for the designer. The hierarchy defines how the hair moves, and effectively, how different parts of the hair respond to stimulus or movement, such as wind, movement, water and the like. A spline controller may be implemented within the various modules of FIG. 12 or may be a separate spline controller unit.

FIG. 28 illustrates some of the capabilities available using the spline modeling techniques described hereinabove. By incorporating procedural spline modeling, the hair strand may be twisted, braided or the like. This capability enables the designer to treat the graphic feature's contour as a three dimensional structure. It can be reshaped, twisted and moved into a variety of positions. These possible positions, such as those illustrated in FIG. 38, are managed real-time, and do not require the off-line 3-D modeling of prior art systems. The spline modeling applied to a given graphic feature may be used as part of the definition of the graphic feature. The exposed variables, such as transparency, twist, scale, mesh material and more may move with the graphic feature. The graphic feature has its own properties. It can be exchanged for another graphic feature without losing the spline modeling.

In FIGS. 39 and 40, example spline structures of the various graphic features are illustrated, wherein the features of a given graphic feature can stay with that feature. The splines may be positioned throughout the hair, to provide a comprehensive hierarchy. This gives flexibility to the designer, reduces the manual and multiplicity of processing systems and tools. The designer is given a streamlined powerful tool to build animations. All or some of these capabilities are adjustable at real-time rendering, and are possible within a single software tool.

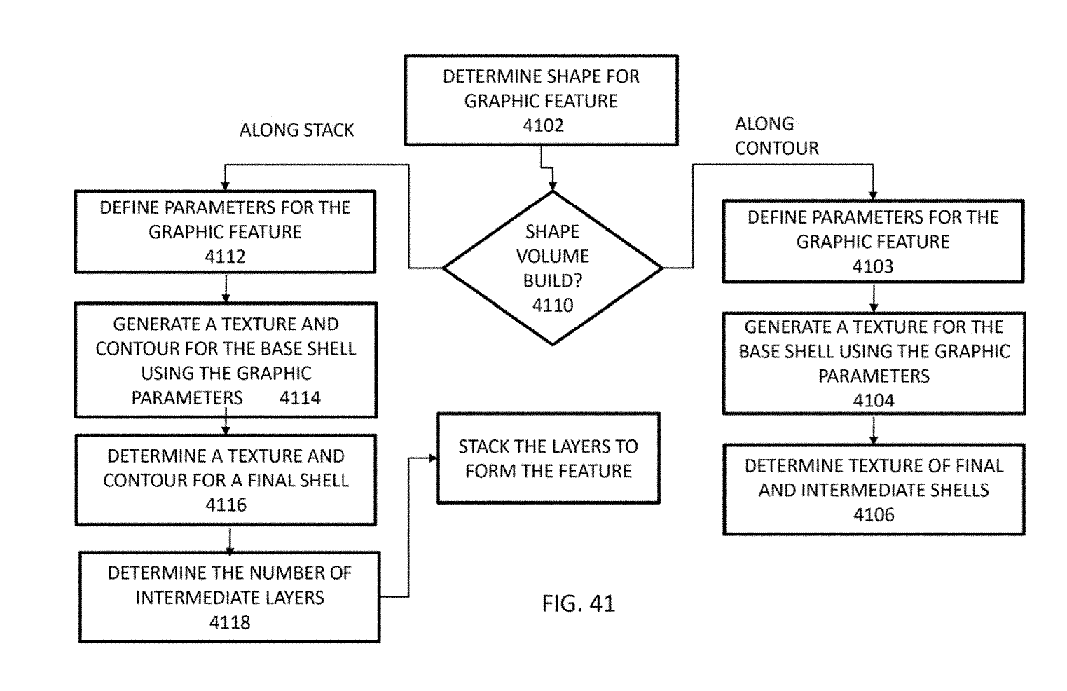

FIG. 41 illustrates a method and process 4100 for producing graphic features, where the shape of the graphic feature is determined, 4012. Process 4100 starts by determining or identifying a shape of a feature, such as hair, along a contour. The process offers flexibility in determining the type of volume desired for the graphic feature, 4110. If the shape volume is to be built along the contour of individual shells, such as the hair features of FIGS. 30-33, processing continues to determine the parameters for the graphic feature, 4103. From the parameters a texture is generated for the base shell, 4104. The process then generates the texture of the shape along the contour within a base shell, 4104. Then creates additional shells having the texture similar to the shape in the base shell. This process may be repeated or modified to achieve a variety of results. The process determines the texture of final and intermediate shells, 4106, using methods and apparatuses described hereinabove. The parameters may include an outline shape, a length within a shell, color and transparency distribution within a shell, and a contour of a shell or shells. These are used to then generate the texture for a shell.

Continuing with FIG. 41, if the shape volume build is formed by the vertical stack structure, 4110, parameters of the graphic feature are determined, 4112. The parameters are used to generate a texture and contour for the base shell 4114. A texture and contour for the final shell is determined, 4116. The number of intermediate layers are generated based on the base shell and final shell. The texture of each shell comprises multiple polygons, wherein each polygon has colored and transparent portions to achieve the desired result. In some embodiments, each shell has a unique contour. The parameters may include an polygon shape, color and transparency distribution within a shell, and a contour of a shell. These are used to then generate the texture for a shell.

As described hereinabove, a method and apparatus for generating graphic features for animation, video or illustration are described which use textured layering to build graphic features having contours and volume. These structures may be used for fur or other fibrous structures by using a set of shells, including a base shell and a top shell with intermediate shells to achieve volume. The method determines the number and texturing of intermediate layers to stack between the base layer and the end layer. The layers are patterned with color and transparency. Patterns may be used to achieve desired results, such as to enable the three dimensional contours.

For hair, and other clumped structures, the texture may be designed into each shell so that the shell contains the length of a strand of hair. The combination of the layers provides volume to the hair strand. This type of graphic feature structure enables a wide variety of positions and directions for the hair. The resultant structures appear more life-like and reduce the time required to render such features as well as reducing the computational power required.

Additional aspects of the present invention provide methods and apparatuses to manage visual aspects of movement within a video graphic product. One of these methods is to manage a consistent realistic appearance to the viewer as a character or animation moves from close to distance within an environment. As an example, a character may be close to the viewer position and running from the viewer position further into the video environment. This movement typically incurs significant computationally time for rendering. According to the present invention, during such movement, shells are dynamically removed from the shell structure.

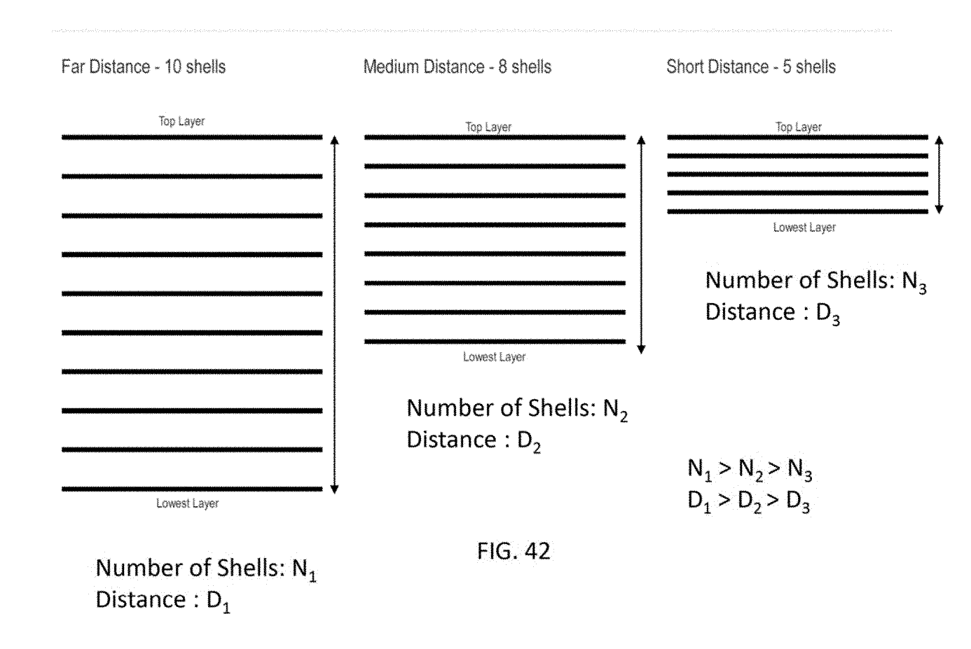

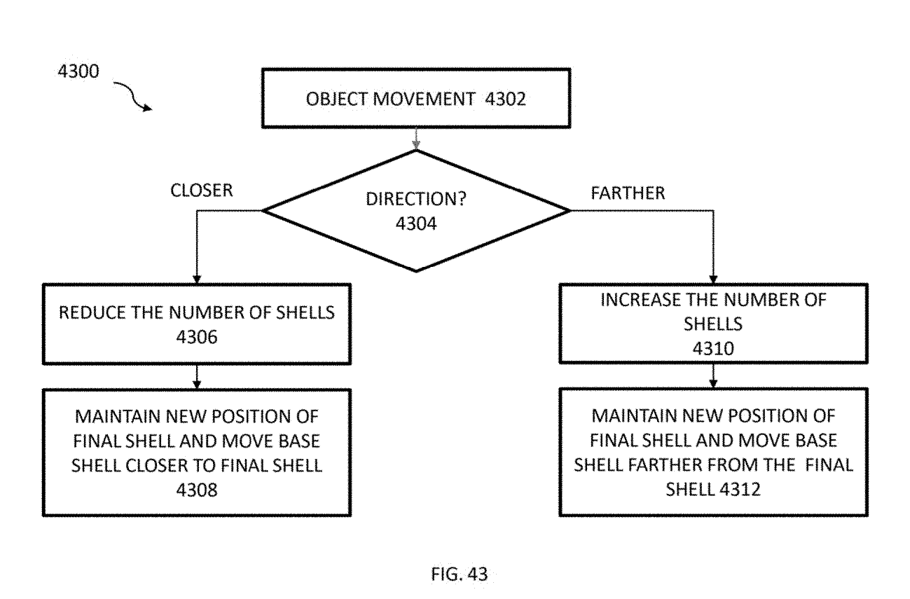

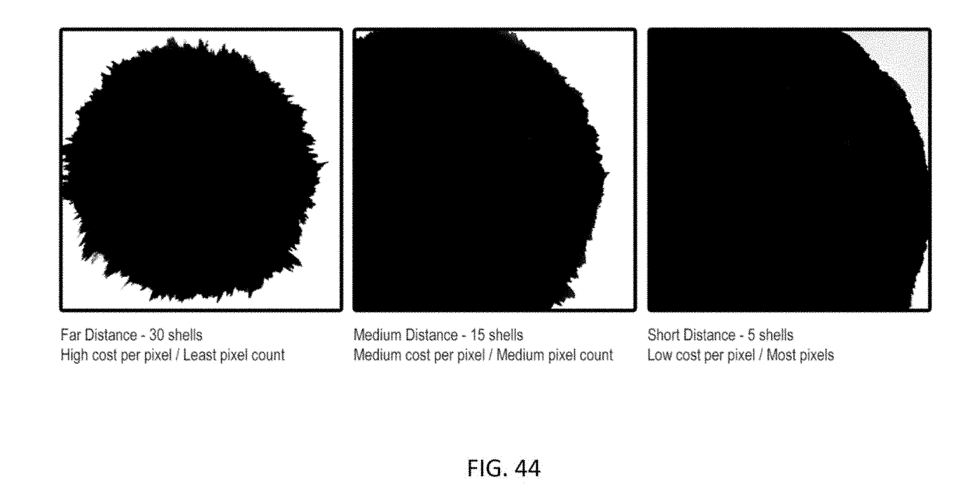

In some aspects of the present invention, a method for designing near to distant shell compression creates a more realistic movement of characters and objects. At longer distances, the shells have a first number of intermediate shells, N₃, and a first distance between end shells, D₁. As the feature moves closer to the viewer, the intermediate shells are dynamically removed to N₂ and the overall spacing of shells is decreased to D₂ as illustrated in FIG. 42. As illustrated, the number of shells decreases as the distances decreases. This near distance shell compression technique provides a smooth movement when rendered in the video. FIG. 43 illustrates an object that is at first large on the screen, and as it moves away from the screen, such as to zoom out or as the object moves shells are removed, while the shell configuration, stack, becomes much less dense. This aspect of the present invention increases rendering speed, reducing latency for the viewer. Without this adjustment, at closer distances the number of pixels for the fur shader as well as the density of the shells acts to increase the cost per pixel. By removing shells, the process decreases the cost per pixel while simultaneously increasing the number of pixels using the fur shader. In this way, the process acts as a load balance enabling the system to maintain a substantially consistent frame rate. As these modifications are made dynamically during movement, it is difficult to discern by the viewer, and seems like a smooth motion with reduces rendering latency. At close distances, the object is difficult for the viewer to observe as it takes up more of the screen. As the silhouette of the object is more difficult to observe and therefore, fewer shells are needed for a less fine granularity image. The illusion of the silhouette is not as accurate at very close distances, and therefore the number of shells required is decreased. The present invention provides a smart, responsive method to optimize the speed and quality of images by adjusting the number of shells and thus pixels to render.

One embodiment of the invention adjusts the number of shells using a volume preservation method. According to this method, as the distance reduces the process raises the lowest layer, base shell, instead of lowering the top layer, final shell. This enables the process to retain the perceived volume of the original object, fur. In this way, the fur does not appear to thin out or shrink as shells are removed; rather, the process preserves the illusion of volume the object occupies. The volume preservation technique improves performance and appearance of objects is applicable to a variety of conditions and circumstances.

FIG. 43 illustrates an embodiment of these methods, where the process, 4300, begins when an object moves, 4302. If the object is moving away from the viewer, 4304, and moves to a farther point, the process increases the number of shells, 4310. In some embodiments, the final shell position is determined and the distance to the base shell is increased, 4312. This increases the number of shells to visualize the volume of the object. Other embodiments may implement a variety of schemes for dynamically adjusting the number of shells and/or the distance between base and final, top shells.

In alternate embodiments, similar modifications or adjustments may be used to generate movement of objects, such as a bouncing ball, or other object movement in a variety of directions. As 3-D images, there are a variety of methods to implement these adjustments. The specific modification made may be dependent on the type of object or feature that is modified, as well as the prominence of the object. For example, where the object is a small toy close to the screen, but the main focus of the scene is the little girl playing with the small toy, then the small toy may use a coarse granularity and result in fewer shells. The girl's movements will use a fine granularity to give a realistic impression. If the girl spins around, these techniques may be added to enhance the swirl while reducing the computational burden and increase the speed of rendering.

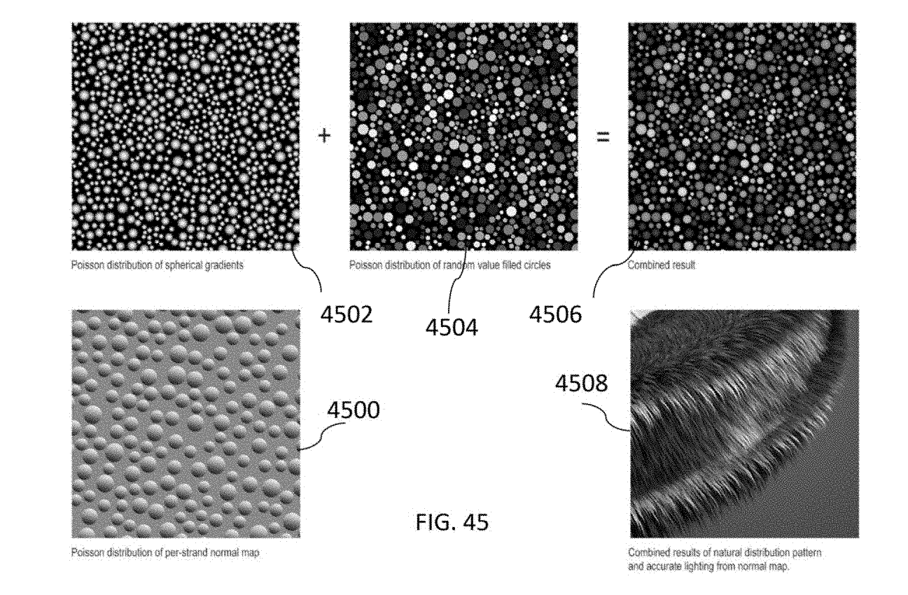

In some aspects of the present invention the textures there are a variety of techniques and methods to build the textures, select the polygons and determine the colored and transparent portions. The present invention may be used in coordination with distribution models, such as a Poisson algorithm for distribution, to generate textures for use in pattern distribution. For example, this combination may generate textures for fur pattern distribution. Examples of these distributions are illustrated in FIG. 45. A texture sample 4500 is a Poisson distribution of per-strand normal map. One texture sample 4502 is a Poisson distribution of spherical gradients. A second texture sample 4504 is a Poisson distribution of random value filled circles. The samples 4502, 4504, are combined resulting in texture sample 4506. There are a variety of ways to combine and configure these textures. Also illustrated, is a combined result of natural distribution pattern and accurate lighting from normal mapping, 4508.

As illustrated in FIG. 45, two textures with substantially identical distribution are combined. One texture has a circular gradient at the position of each strand, referred to as a height map. Another texture has a random distribution of values at the location of each strand, referred to as an ID map. When combined via a red and green channel of a single DXT texture. From this the process may generate normal maps for each strand, a 3-D projection in 2-D space. These follow the distribution algorithm. Other algorithms may be used to build the textures according to the goals and constraints of the design.

These maps may be used in combination with a variety of calculations, including simple mathematics, to drive many properties of the strands via standard gradient mapping techniques. As an example, where the process pre-calculates a random distribution, it may further perform simple calculations to apply color to a percentage of hair strands or hair volume. Similarly, the process may make a percentage of the hairs shorter than the rest of the hairs. This and other texture generating methods may be implemented in the texture control module 1214 of FIG. 12.

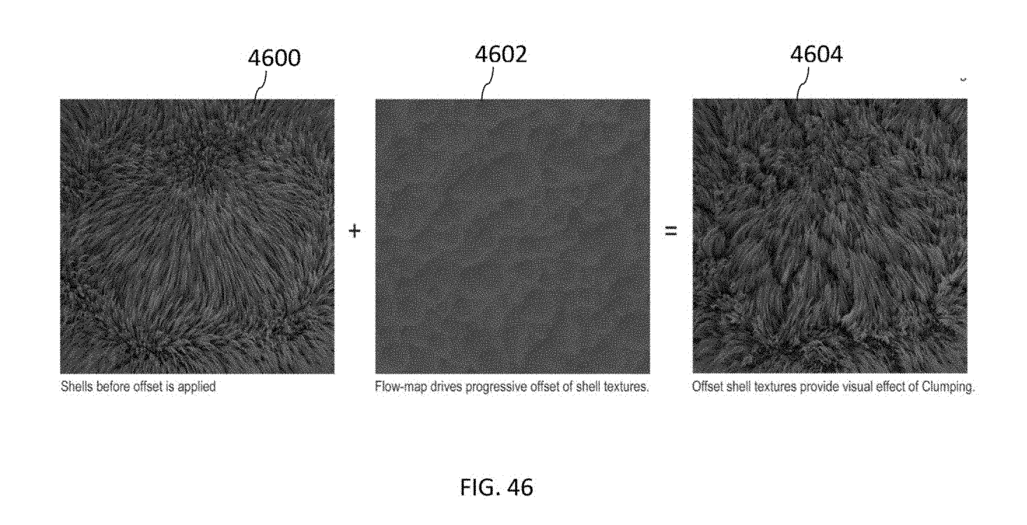

In another aspect of the present invention, using vector direction maps, referred to as flow maps, are used to drive clumping of strands via distortion. Starting at the base, each shell is progressively offset based on the X+Y values of the flow map. As illustrated in FIG. 46, The flow maps are generated with a Poisson-type algorithm for organic randomness, but purposely overlapping with soft edges to generate random variations. This is used to simulate random clumping and roughing-up of the strands across a surface, lending a messy look when desired. In the present example, the shell is illustrated prior to offset, 4600. The flow map 4602 to drive progressive offset of shell textures (as seen in 4600) is illustrated. When the two are used together, the result is a modification of the original shell configuration. A variety of flow maps may be used to achieve a variety of results. In some embodiments, more than one flow map is incorporated. In some embodiments, this is used for a portion of the fur, while other flow maps are used for other portions of the fur. As illustrated in FIG. 46, flow map clumping is driven by flow maps generated using a distribution algorithm for randomness. The incorporation of randomness to a These processes may be controlled by texture controller 1214, offset controller 1216 and or distribution controller 1218 of FIG. 12.

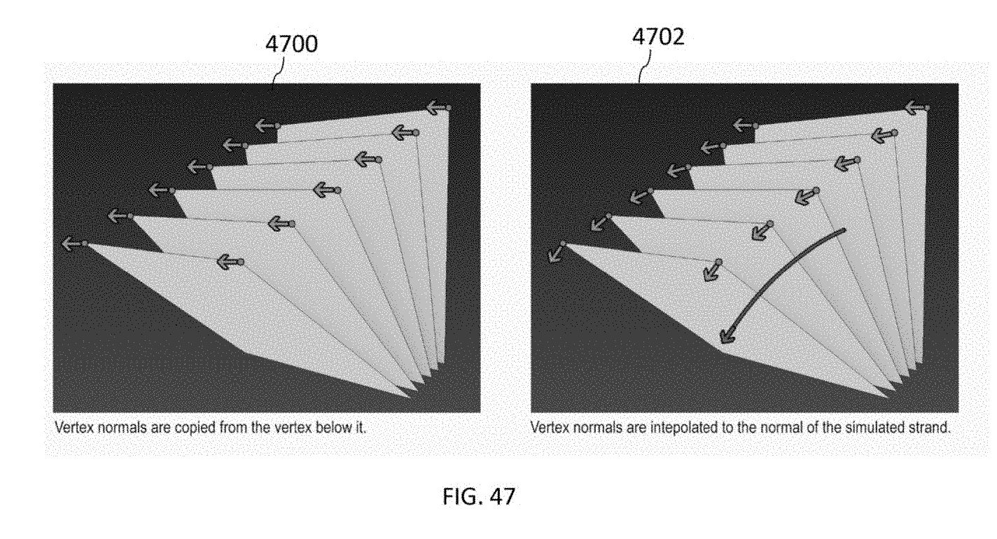

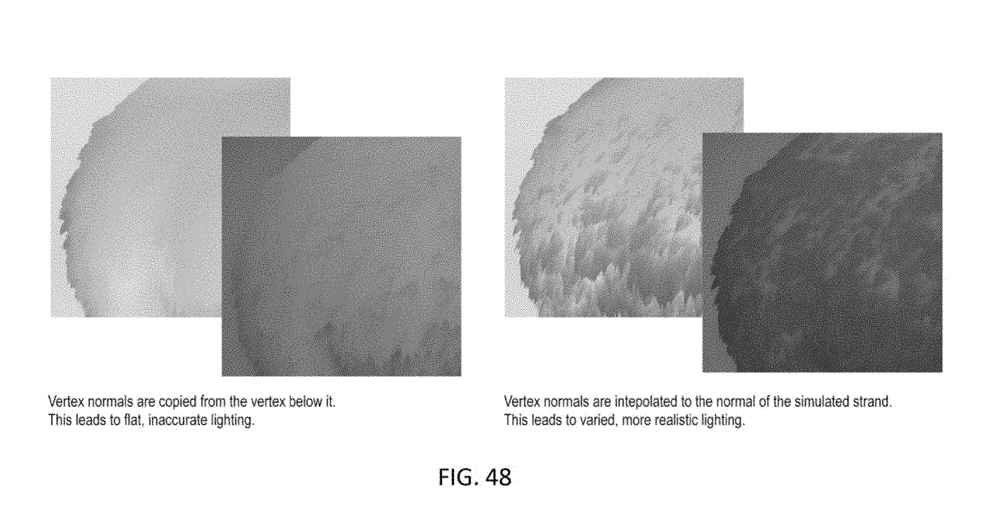

In still other aspects of the present invention, the process interpolates between the original vertex normal and the normal of the simulated end of strand. This is an improvement over other techniques in which shells use the vertex normal of the base mesh from which they are generated. In the present invention, the interpolation technique provides each vertex in the shell a more accurate normal and creates more accurate lighting across the mesh. This is illustrated in FIGS. 47 and 48. The vertex normal may be copied from the previous vertex, 4700. The vertex normal may be interpolated to the normal of the simulated strand.

In another aspect of the present invention, to improve performance a single start and end position for each control point is utilized in a physics simulation. Then a mathematical exponent is incorporated to create a simulated bend for each control point, and interpolate the shells vertex positions along this bend, as in FIG. 48. Such processing using a bend exponent results in a fur appearance as a full strand simulation, while maintaining computational simplicity.

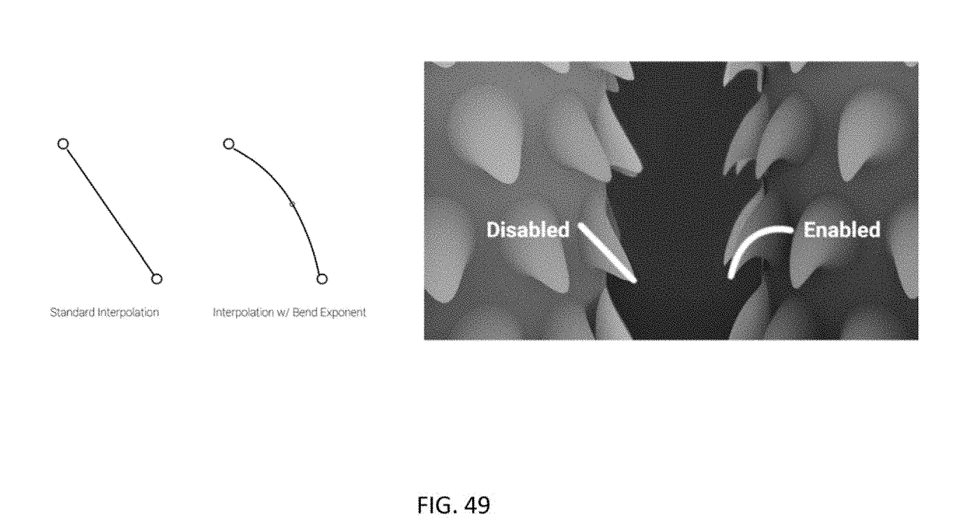

FIG. 49 illustrates methods of standard interpolation and interpolation bend exponent in generating hair and fur.

As provided herein, a variety of methods and apparatuses to generate various graphic features, such as fur and hair, that improve the realism as viewed while reducing the computing and memory complexity. Modeling features using non-linear contours and positioning a number of intermediate shells to achieve a desired look provide more realistic images while reducing processing time. The intermediate shells may be generated by interpolation of the base and final shells. These processes may be used to build a variety of features, and are particularly suited for grass, hair, fur and so forth.

The processes and techniques described hereinabove may be implemented in a single software product or software controlled hardware, or may be implemented by distributed modules which act in concert to provide these capabilities. The structures described, which are defined by the polygon shapes used, the contour of the shells, the relation of shells and the scaling of polygons among the layers, provide the designer with great flexibility to change parameters of the design. Such modifications and adjustments may be done while the video is rendered in real time, giving immediate and direct results to the designer. From the polygon shape, the density and color/transparency ratio may be adjusted to change the appearance of a feature over a wide range of values.

Alternate methods are presented herein for defining the shape of a feature within the contour of a shell, such as to create 3-D images of a tuft of hair. The result is hair having volume seen from a variety of perspectives. Some techniques described herein are used to provide shadow and light to the feature, such as light shining on fur, and to change the color gradation of a portion of hair.

In other aspects, a spline is positioned within a strand of hair, or other feature, that enables the 3-D voluminous feature to make 3-D movements, such as to twist or braid hair. This expands the capabilities of the designer and maintains a consistent appearance.

In another aspect, a process is described that increases the number of shells used as the distance from the viewer increases and decreases the number of shells as the distance decreases. Such methods achieve superior results, as the edges of close up images do not require a fine detail, while distant images require such fine detail. The stretching of the distance between base and top shells is done by first positioning the top layer and then adjusting the base layer with respect to the top layer.

These and other methods and techniques may be built combined to enhance generation of video content and reduce the computational burden of creating, storing and rendering the same.

1. A method for generating graphic feature, comprising:
receiving a request for a first the graphic feature, the graphic feature having a set of contours and a contour volume;
generating a base shell for the graphic feature, the base shell having a first contour and a first texture from the set;
generating a base shell texture;
generating a top shell for the graphic feature, the top shell having a second contour and a second texture from the set;
generating a top shell texture based on the base shell texture;
determining a number of intermediate shells for the graphic feature;
for each of the intermediate shells, generating a texture;
configuring the intermediate shells between the base shell and the top shell to form the contour; and
storing definitions of the graphic feature in a format to enable rendering and display.

2. The method as in claim 1, wherein the graphic feature is a fur structure, and textures of the shells form strands of fur.

3. The method as in claim 2, wherein the textures of the shells are a function of the density of the fur.

4. The method as in claim 2, wherein the strands of fur each have a curvature along the length of the strand.

5. The method as in claim 1, further comprising:
positioning a spline within the graphic feature; and
twisting the graphic feature with respect to the spline.

6. The method as in claim 1, wherein the graphic feature is part of an animation work.

7. The method as in claim 1, wherein each texture of each shell comprises:
a colored pattern; and
a transparency pattern.

8. The method as in claim 7, wherein polygons in each shell correspond to polygons in bordering shells, wherein each shell has a contour to achieve the curvature of the graphic feature.

9. A method for generating hair for video graphic work, comprising:
determining an outline of a strand of the hair;
texturing a shell to form the outline of the strand of the hair in the contour of the shell; and
storing definitions of the shell in a format to enable rendering and display.

10. The method of claim 9, wherein the length of the strand of hair is contained within the shell.

11. A system for computer-generation of video graphic content, comprising:
a user interface for inputting specifications for a graphic feature;
a shell generator for generating a base shell, a top shell and intermediate shells;
a shell layer controller for calculating a number of intermediate shells; and
a texture controller for generating a texture for each shell.

12. A system for rendering a video graphic content, comprising:
a memory storage storing parameters of the feature, including shell information,
feature placement information and texture information; and
render controller for:
compiling the parameters to generate the feature having a textured base shell, a textured top shell, and a variable number of intermediate shells;
stacking the shells, wherein the distance between successive shells is not constant; and
displaying the stack to illustrate the feature.

13. The system as in claim 12, further comprising:
a control module responsive to inputs from a user interface, and operative to control multiple functions within the system;
a shell generator to develop a base shell, a top shell and intermediate shells; and
a contour definition stored in memory defining a contour of at least one shell.

14. The system as in claim 13, wherein the parameters define a volume of the graphic feature.

15. The system as in claim 14, wherein graphic feature shape is contained with the contour of a shell.

16. A method for generating dynamic graphic modifications to reflect movement of an element in a video graphic work, comprising:
identifying a first location of the element, having a base shell, a top shell, and a first number of intermediate shells;
on movement of the element away from the viewer's perspective, generating a second number of intermediate shells greater than the first number of intermediate shells, and increasing the distance between the base and top shells.

17. The method as in claim 16, wherein the element is fur that is textured using polygons positioned on each shell.

18. The method as in claim 17, further comprising:
Forming a first texture pattern for the element;
Forming a second random texture pattern; and
Combining the first texture pattern and the second random texture pattern to form the element.

19. The method as in claim 18 further comprising:
on movement of the element toward the viewer's perspective, removing a third number of intermediate shells, and decreasing the distance between the base and top shells.

20. The method as in claim 18, wherein the forming the second random texture pattern comprises:
using a Poisson distribution to generate a random texture.
